(19) United States
(12) Patent Application Publication
(10) Pub. No.: US 2008/0117849 A1
(43) Pub. Date: May 22, 2008

(54) METHOD AND APPARATUS FOR INTERACTION OF FAST OTHER SECTOR INTERFERENCE (OSI) WITH SLOW OSI

(75) Inventors: Mohammad J. Borran, San Diego, CA (US); Tingfang Ji, San Diego, CA (US); Arumugam Chendamari Kannan, San Diego, CA (US); Alexei Gorokhov, San Diego, CA (US); Aamod Khandekar, San Diego, CA (US)

Correspondence Address: QUALCOMM INCORPORATED, 5775 MOREHOUSE DR., SAN DIEGO, CA, 92121, US

(73) Assignee: QUALCOMM Incorporated

(21) Appl. No.: 11/848,664

(22) Filed: Aug. 31, 2007

Related U.S. Application Data
(60) Provisional application No. 60/843,219, filed on Sep. 8, 2006.

(51) Int. Cl. G08C 17/00

(52) U.S. Cl. 370/311

(57) ABSTRACT

Systems and methodologies are described that provide techniques for generating and utilizing reverse link feedback for interference management in a wireless communication system. Other Sector Interference (OSI) indicators are transmitted from an interfering access point to an access terminal. At the access terminal, an appropriate delta value(s) is combined with the received OSI indicators. The combined information is transmitted to the access point in a feedback so the serving sector access point can analyze the amount of interference. Based on the provided feedback from the terminal, the serving sector access point can assign resources for use by the terminal in communication with the serving sector.

### CROSS-REFERENCE

This application claims the benefit of U.S. Provisional Application Ser. No. 60/843,219, filed Sep. 8, 2006, and entitled “A METHOD AND APPARATUS FOR INTERACTION OF FAST OTHER SECTOR INTERFERENCE (OSI) WITH SLOW OSI,” the entirety of which is incorporated herein by reference.

### BACKGROUND

I. Field

The present disclosure relates generally to wireless communications, and more specifically to techniques for power and interference control in a wireless communication system.

II. Background

Wireless communication systems are widely deployed to provide various communication services; for instance, voice, video, packet data, broadcast, and messaging services can be provided via such wireless communication systems. These systems can be multiple-access systems that are capable of supporting communication for multiple terminals by sharing available system resources. Examples of such multiple-access systems include Code Division Multiple Access (CDMA) systems, Time Division Multiple Access (TDMA) systems, Frequency Division Multiple Access (FDMA) systems, and Orthogonal Frequency Division Multiple Access (OFDMA) systems.

A wireless multiple-access communication system can simultaneously support communication for multiple wireless terminals. In such a system, each terminal can communicate with one or more sectors via transmissions on the forward and reverse links. The forward link (or downlink) refers to the communication link from the sectors to the terminals, and the reverse link (or uplink) refers to the communication link from the terminals to the sectors. These communication links can be established via a single-in-single-out out (SISO), multiple-in-single-out, and/or multiple-in-multiple-out (MIMO) systems.

Multiple terminals can simultaneously transmit on the reverse link by multiplexing their transmissions to be orthogonal to one another in the time, frequency, and/or code domain. If complete orthogonality between transmissions is achieved, transmissions from each terminal will not interfere with transmissions from other terminals at a receiving sector. However, complete orthogonality among transmissions from different terminals is often not realized due to channel conditions, receiver imperfections, and other factors. As a result, terminals often cause some amount of interference to other terminals communicating with the same sector. Furthermore, because transmissions from terminals communicating with different sectors are typically not orthogonal to one another, each terminal can also cause interference to terminals communicating with nearby sectors. This interference results in a decrease in performance at each terminal in the system. Accordingly, there is a need in the art for effective techniques to mitigate the effects of interference in a wireless communication system.

### SUMMARY

The following presents a simplified summary of the disclosed embodiments in order to provide a basic understanding of such embodiments. This summary is not an extensive overview of all contemplated embodiments, and is intended to neither identify key or critical elements nor delineate the scope of such embodiments. Its sole purpose is to present some concepts of the disclosed embodiments in a simplified form as a prelude to the more detailed description that is presented later.

Systems and methodologies are described that provide techniques for generating and utilizing reverse link feedback for interference management in a wireless communication system. Other Sector Interference (OSI) indicators are transmitted from an access point from which excessive interference is observed to an access terminal. At the access terminal, an appropriate delta value(s) is adjusted based on the received OSI indicators. The combined information can then be transmitted as feedback to a serving access point, based on which the serving access point can assign resources for use by the terminal in communication with the serving access point. By assigning resources in this manner, the overall interference observed in a wireless communication system can be reduced.

According to one aspect, a method for providing feedback for power control in a wireless communication system is provided herein. The method can include receiving one or more slow other sector interference (OSI) indications and one or more fast OSI indications from one or more neighboring access points. Further, the method can include maintaining one or more delta values based on the received OSI indications and adjusting a resource used for transmissions to a serving access point based at least in part on the delta values.

Another aspect relates to a wireless communications apparatus. The wireless communications apparatus can include a memory that stores data relating to one or more OSI indications received from one or more non-serving sectors and one or more delta values. Further, the wireless communications apparatus can include a processor configured to adjust the delta values based on the one or more OSI indications and to modify a parameter for transmissions to a serving sector based at least in part on the delta values.

Yet another aspect relates to an apparatus that facilitates reverse link power control and interference management in a wireless communication system. The apparatus can include means for receiving one or more OSI indications from one or more non-serving sectors. Further, the apparatus can include means for adjusting one or more delta values based on the one or more OSI indications. In addition, the apparatus can comprise means for modifying one or more communication resources based at least in part on the delta values.

Still another aspect relates to a computer-readable storage medium The computer-readable storage medium can include code for causing a computer to receive one or more OSI indications from one or more non-serving base stations. In addition, the computer-readable storage medium can comprise code for causing a computer to modify one or more delta values based at least in part on the one or more OSI indications. The computer-readable storage medium can further comprise code for causing a computer to compute one or more of a bandwidth and a transmit power for communication with a serving base station based at least in part on the delta values.

A further aspect relates to an integrated circuit that executes computer-executable instructions for interference control in a wireless communication system. The instructions can include maintaining a reference power level, receiving one or more OSI indications, adjusting one or more delta values based on the received one or more OSI indications, and computing a transmit power at least in part by adding one or more of the delta values to the reference power level.

To the accomplishment of the foregoing and related ends, one or more embodiments comprise the features hereinafter fully described and particularly pointed out in the claims. The following description and the annexed drawings set forth in detail certain illustrative aspects of the disclosed embodiments. These aspects are indicative, however, of but a few of the various ways in which the principles of various embodiments can be employed. Further, the disclosed embodiments are intended to include all such aspects and their equivalents.

### BRIEF DESCRIPTION OF THE DRAWINGS

FIG. 1 illustrates a wireless multiple-access communication system in accordance with various aspects set forth herein.

FIG. 2 is a block diagram of a system that facilitates reverse link power control and interference management in a wireless communication system in accordance with various aspects.

FIGS. 3A-3B are block diagrams of a system that facilitate reverse link power control and interference management in a wireless communication system in accordance with various aspects.

FIG. 4 is a flow diagram of a methodology for conducting reverse link power level maintenance in a wireless communication system.

FIG. 5 is a flow diagram of a methodology for conducting reverse link power level maintenance based on a received interference indication in a wireless communication system.

FIG. 6 is a block diagram illustrating an example wireless communication system in which one or more embodiments described herein can function.

FIG. 7 is a block diagram of a system that coordinates reverse link power level maintenance in a wireless communication system in accordance with various aspects.

FIG. 8 is a block diagram of a system that coordinates reverse link power control and interference management in a wireless communication system in accordance with various aspects.

FIG. 9 is a block diagram of an apparatus that facilitates reverse link transmission resource adjustment and interference management in a wireless communication system.

FIG. 10 is a block diagram of an apparatus that facilitates reverse link transmission adjustment based on a received interference indication in a wireless communication system.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more aspects. It can be evident, however, that such embodiment(s) can be practiced without these specific details. In other instances, well-known structures and devices are shown in block diagram form in order to facilitate describing one or more embodiments.

As used in this application, the terms “component,” “module,” “system,” and the like are intended to refer to a computer-related entity, either hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

Furthermore, various embodiments are described herein in connection with a wireless terminal and/or a base station. A wireless terminal can refer to a device providing voice and/or data connectivity to a user. A wireless terminal can be connected to a computing device such as a laptop computer or desktop computer, or it can be a self contained device such as a personal digital assistant (PDA). A wireless terminal can also be called a system, a subscriber unit, a subscriber station, mobile station, mobile, remote station, access point, remote terminal, access terminal, user terminal, user agent, user device, or user equipment. A wireless terminal can be a subscriber station, wireless device, cellular telephone, PCS telephone, cordless telephone, a Session Initiation Protocol (SIP) phone, a wireless local loop (WLL) station, a personal digital assistant (PDA), a handheld device having wireless connection capability, or other processing device connected to a wireless modem. A base station (e.g., access point) can refer to a device in an access network that communicates over the air-interface, through one or more sectors, with wireless terminals. The base station can act as a router between the wireless terminal and the rest of the access network, which can include an Internet Protocol (IP) network, by converting received air-interface frames to IP packets. The base station also coordinates management of attributes for the air interface.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) ... ), smart cards, and flash memory devices (e.g., card, stick, key drive . . . ).

Various embodiments will be presented in terms of systems that can include a number of devices, components, modules, and the like. It is to be understood and appreciated that the various systems can include additional devices, components, modules, etc. and/or can not include all of the devices, components, modules etc. discussed in connection with the figures. A combination of these approaches can also be used.

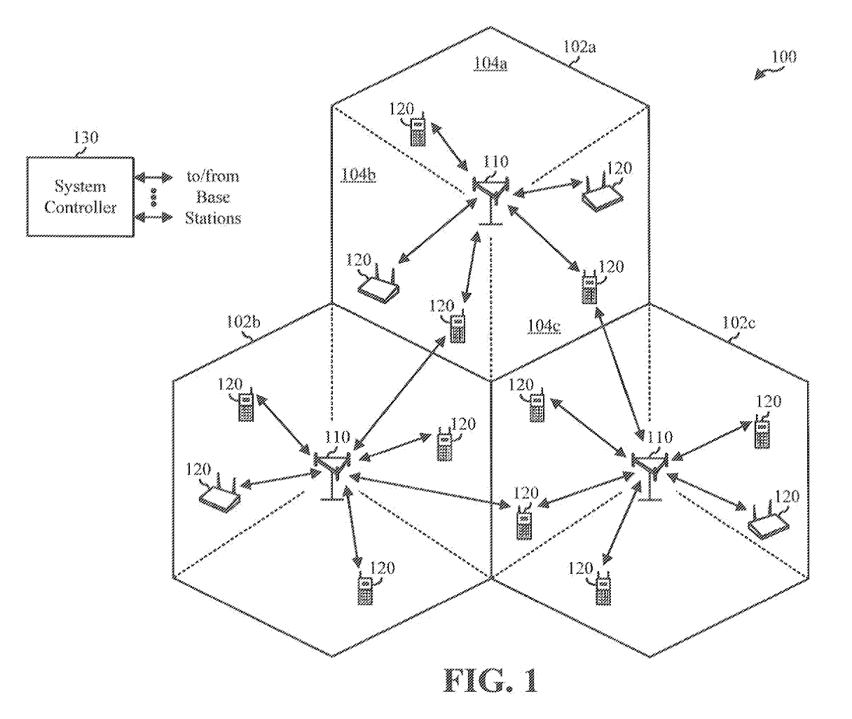

Referring now to the drawings, FIG. 1 is an illustration of a wireless multiple-access communication system 100 in accordance with various aspects. In one example, the wireless multiple-access communication system 100 includes multiple base stations 110 and multiple terminals 120. Further, one or more base stations 110 can communicate with one or more terminals 120. By way of non-limiting example, a base station 110 can be an access point, a Node B, and/or another appropriate network entity. Each base station 110 provides communication coverage for a particular geographic area 102a-c. As used herein and generally in the art, the term “cell” can refer to a base station 110 and/or its coverage area 102 depending on the context in which the term is used.

To improve system capacity, the coverage area 102 corresponding to a base station 110 can be partitioned into multiple smaller areas (e.g., areas 104a, 104b, and 104c). Each of the smaller areas 104a, 104b, and 104c can be served by a respective base transceiver subsystem (BTS, not shown). As used herein and generally in the art, the term “sector” can refer to a BTS and/or its coverage area depending on the context in which the term is used. In one example, sectors 104 in a cell 102a can be formed by groups of antennas (not shown) at base station 110, where each group of antennas is responsible for communication with terminals 120 in a portion of the cell 102. For example, a base station 110 serving cell 102a can have a first antenna group corresponding to sector 104a, a second antenna group corresponding to sector 104b, and a third antenna group corresponding to sector 104c. However, it should be appreciated that the various aspects disclosed herein can be used in a system having sectorized and/or unsectorized cells. Further, it should be appreciated that all suitable wireless communication networks having any number of sectorized and/or unsectorized cells are intended to fall within the scope of the hereto appended claims. For simplicity, the term “base station” as used herein can refer both to a station that serves a sector as well as a station that serves a cell. As further used herein, a “serving” access point is one with which a given terminal primarily engages in forward link and/or reverse link traffic transmissions, and a “neighbor” access point is one with which a given terminal is does not primarily communicate traffic data. While the following description generally relates to a system in which each terminal communicates with one serving access point for simplicity, it should be appreciated that terminals can communicate with any number of serving access points. For example, terminals 120 in system 100 may communicate with various base stations 110 using disjoint links, wherein a given terminal 120 can have different serving sectors for the forward and reverse links. In such an example, a forward link serving sector can be treated as a neighbor sector for interference management purposes. In another example, an access terminal may conduct traffic transmissions on the forward link or control transmissions on the forward and/or reverse links with a non-serving neighbor sector.

In accordance with one aspect, terminals 120 can be dispersed throughout the system 100. Each terminal 120 can be stationary or mobile. By way of non-limiting example, a terminal 120 can be an access terminal (AT), a mobile station, user equipment, a subscriber station, and/or another appropriate network entity. A terminal 120 can be a wireless device, a cellular phone, a personal digital assistant (PDA), a wireless modem, a handheld device, or another appropriate device. Further, a terminal 120 can communicate with any number of base stations 110 or no base stations 110 at any given moment.

In another example, the system 100 can utilize a centralized architecture by employing a system controller 130 that can be coupled to one or more base stations 110 and provide coordination and control for the base stations 110. In accordance with alternative aspects, system controller 130 can be a single network entity or a collection of network entities. Additionally, the system 100 can utilize a distributed architecture to allow the base stations 110 to communicate with each other as needed. In one example, system controller 130 can additionally contain one or more connections to multiple networks. These networks can include the Internet, other packet based networks, and/or circuit switched voice networks that can provide information to and/or from terminals 120 in communication with one or more base stations 110 in system 100. In another example, system controller 130 can include or be coupled with a scheduler (not shown) that can schedule transmissions to and/or from terminals 120. Alternatively, the scheduler can reside in each individual cell 102, each sector 104, or a combination thereof.

In one example, system 100 can utilize one or more multiple-access schemes, such as CDMA, TDMA, FDMA, OFDMA, Single-Carrier FDMA (SC-FDMA), and/or other suitable multiple-access schemes. TDMA utilizes time division multiplexing (TDM), wherein transmissions for different terminals 120 are orthogonalized by transmitting in different time intervals. FDMA utilizes frequency division multiplexing (FDM), wherein transmissions for different terminals 120 are orthogonalized by transmitting in different frequency subcarriers. In one example, TDMA and FDMA systems can also use code division multiplexing (CDM), wherein transmissions for multiple terminals can be orthogonalized using different orthogonal codes (e.g., Walsh codes) even though they are sent in the same time interval or frequency sub-carrier. OFDMA utilizes Orthogonal Frequency Division Multiplexing (OFDM), and SC-FDMA utilizes Single-Carrier Frequency Division Multiplexing (SC-FDM). OFDM and SC-FDM can partition the system bandwidth into multiple orthogonal subcarriers (e.g., tones, bins, . . . ), each of which can be modulated with data. Typically, modulation symbols are sent in the frequency domain with OFDM and in the time domain with SC-FDM. Additionally and/or alternatively, the system bandwidth can be divided into one or more frequency carriers, each of which can contain one or more subcarriers. System 100 can also utilize a combination of multiple-access schemes, such as OFDMA and CDMA. While the power control techniques provided herein are generally described for an OFDMA system, it should be appreciated that the techniques described herein can similarly be applied to any wireless communication system.

In accordance with one aspect, base stations 110 and/or terminals 120 in system 100 can employ multiple (N_{T}) transmit antennas and/or multiple (N_{R}) receive antennas for data transmission. A MIMO channel formed by N_{T} transmit and N_{R} receive antennas can be decomposed into N_{S} independent channels, which can also be referred to as spatial channels, where N_{S}≦min {N_{T}, N_{R}}. In one example, each of the N_{S} independent channels can correspond to a dimension. By utilizing additional dimensionalities created by multiple transmit and receive antennas, system 100 can achieve higher throughput, greater reliability, and/or other performance gains.

In another example, base stations 110 and terminals 120 in system 100 can communicate data using one or more data channels and signaling using one or more control channels. Data channels utilized by system 100 can be assigned to active terminals 120 such that each data channel is used by only one terminal at any given time. Alternatively, data channels can be assigned to multiple terminals 120, which can be superimposed or orthogonally scheduled on a data channel. To conserve system resources, control channels utilized by system 100 can also be shared among multiple terminals 120 using, for example, code division multiplexing. In one example, data channels orthogonally multiplexed only in frequency and time (e.g., data channels not multiplexed using CDM) can be less susceptible to loss in orthogonality due to channel conditions and receiver imperfections than corresponding control channels.

In accordance with one aspect, system 100 can employ centralized scheduling via one or more schedulers implemented at, for example, system controller 130 and/or each base station 110. In a system utilizing centralized scheduling, scheduler(s) can rely on feedback from terminals 120 to make appropriate scheduling decisions. In one example, this feedback can include delta offset added to the OSI information for feedback in order to allow the scheduler to estimate a supportable reverse link peak rate for a terminal 120 from which such feedback is received and to allocate system bandwidth accordingly.

In accordance with another aspect, reverse link interference control can be used by system 100 to guarantee minimum system stability and quality of service (QoS) parameters for the system. For example, decoding error probability of reverse link (RL) acknowledgement messages can result in an error floor for all forward link transmissions. By employing interference control on the RL, system 100 can facilitate power efficient transmission of control and QoS traffic and/or other traffic with stringent error requirements.

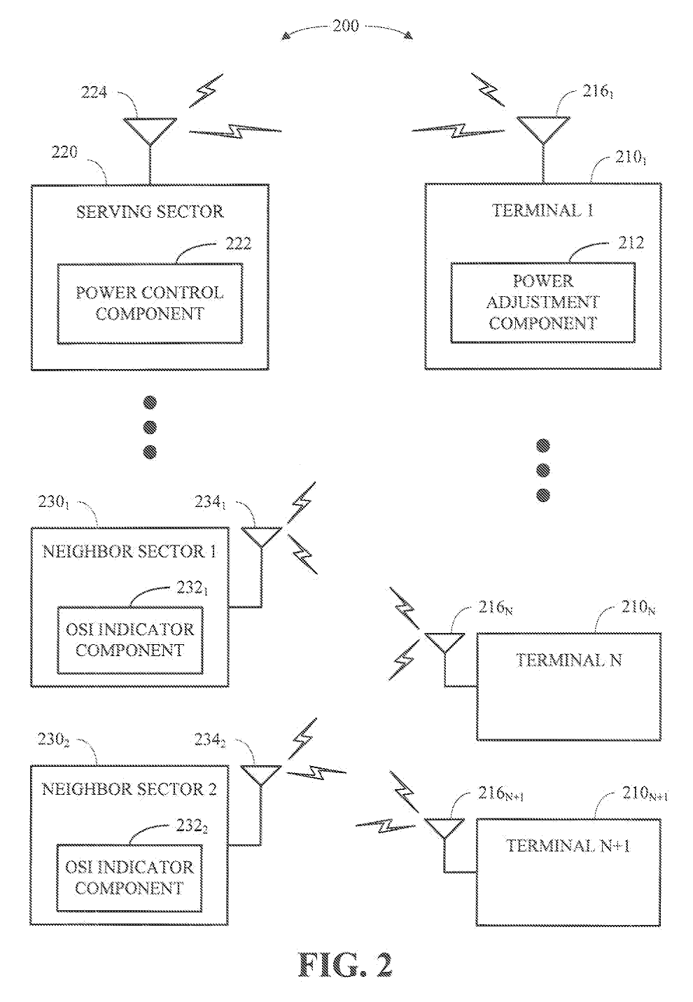

FIG. 2 is a block diagram of a system 200 that facilitates reverse link power control and interference management in a wireless communication system in accordance with various aspects described herein. In one example, system 200 includes a terminal 210₁ that can communicate with a serving sector 220 on the forward and reverse links via one or more antennas 216₁ at terminal 210₁ and one or more antennas 224 at serving sector 220. Serving sector 220 can be a base station (e.g., a base station 110) or an antenna group at a base station. Further, serving sector 220 can provide coverage for a cell (e.g., a cell 102) or an area within a cell (e.g. a sector 104). In addition, system 200 can include one or more neighbor sectors 230 with which terminal 210₁ does not communicate. Neighbor sectors 230 can provide coverage for respective geographic areas that can include all, part, or none of an area covered by serving sector 220 via one or more antennas 234. While serving sector 220 and neighbor sectors 230 are illustrated in system 200 as distinct entities, it should be appreciated that a terminal can utilize different sectors for primary communication on the forward and reverse links. In such an example, a single sector can be a serving sector 220 on the forward link and a neighbor sector 230 on the reverse link and/or vice versa. Additionally, it should be appreciated that a terminal 210 may conduct traffic transmissions on the forward link or control transmissions on the forward and/or reverse links with a neighbor sector 230.

In accordance with one aspect, a terminal 210 and a serving sector 220 can communicate to control the amount of transmit power used by the terminal 210 in communicating with serving sector 220 via one or more power control techniques. In one example, neighbor sectors 230 can transmit OSI indicators, from OSI indicator components 232, to terminal 210. Based on OSI indicators from neighbor sectors 230, a terminal 210 can adjust one or more delta values used to manage resources used for communication with serving sector 220 on the reverse link via a power control component 212. Additionally, the terminal 210 can communicate computed delta values and/or reports of OSI activity caused by the terminal 210 as feedback to serving sector 220. At the serving sector 220, a power control component 222 can then utilize the feedback from a terminal 210 to assign a transmit power and/or other resources for communication to the terminal 2 10. After the power control component 222 generates a transmit power assignment, the serving sector 220 can transmit the assignment back to the terminal 210. The terminal 210 can then accordingly adjust its transmit power based on the assignment via power adjustment component 212.

In accordance with another aspect, power control techniques utilized by entities in system 200 can additionally take into account interference present in system 200. For example, in a multiple access wireless communication system such as an OFDMA system, multiple terminals 210 can simultaneously conduct uplink transmission by multiplexing their transmissions to be orthogonal to one another in the time, frequency, and/or code domain. However, complete orthogonality between transmissions from different terminals 210 is often not achieved due to channel conditions, receiver imperfections, and other factors. As a result, terminals 210 in system 200 will often cause interference to other terminals 210 communicating with a common sector 220 or 230. Furthermore, because transmissions from terminals 210 communicating with different sectors 220 and/or 230 are typically not orthogonal to one another, each terminal 210 can also cause interference to terminals 210 communicating with nearby sectors 220 and/or 230. As a result, the performance of terminals 210 in system 200 can be degraded by the interference caused by other terminals 210 in system 200.

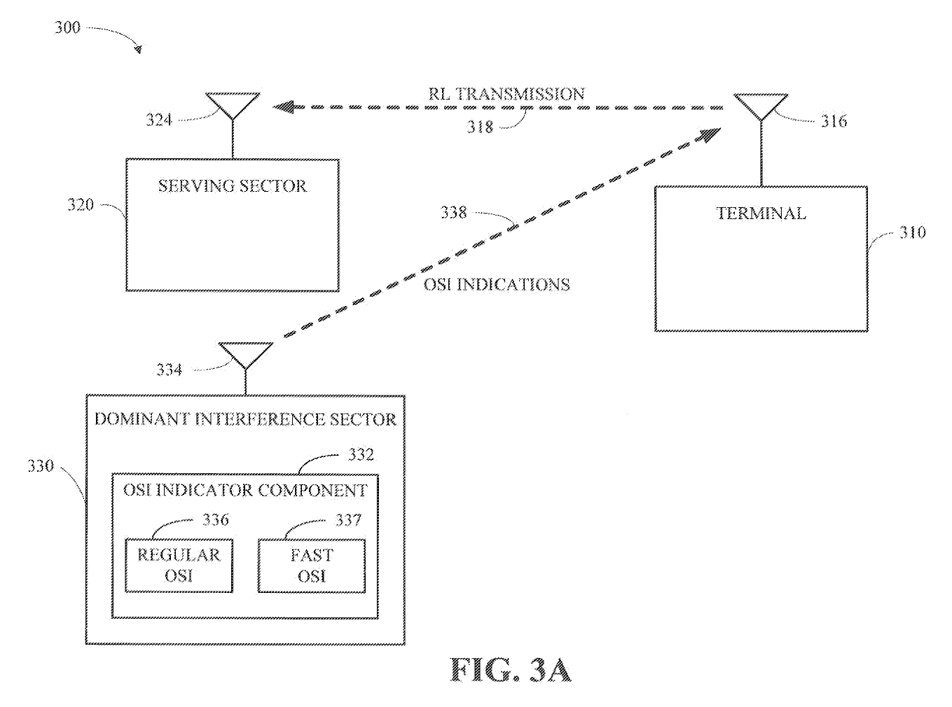

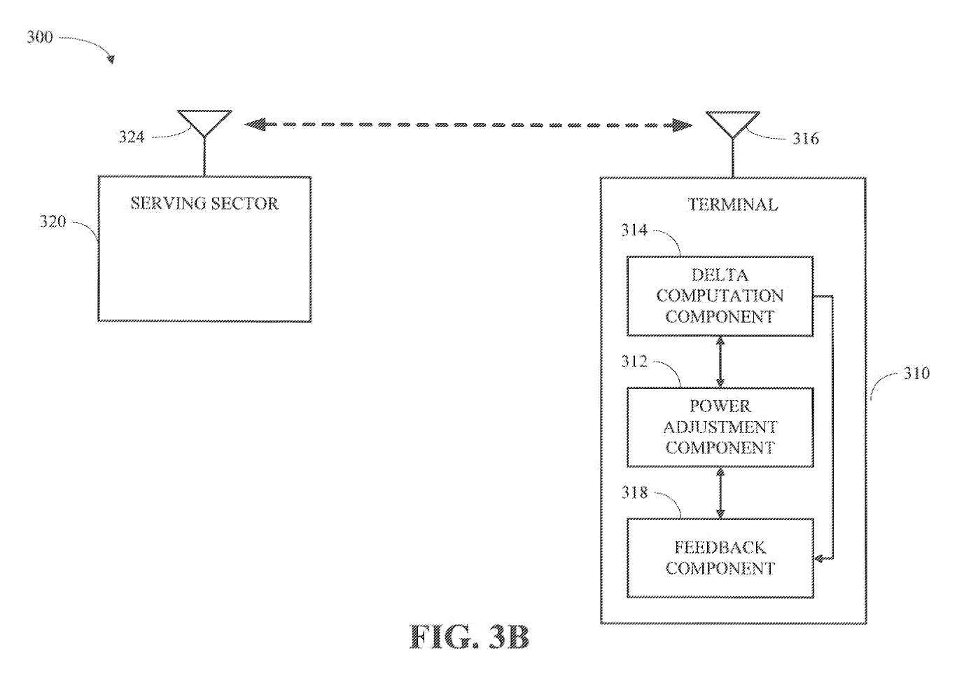

FIGS. 3A-3B are block diagrams that illustrate operation of an example system 300 for power control and interference management in a wireless communication system. In a similar manner to system 200, system 300 can include a terminal 310 in communication with a serving sector 320 on the forward and reverse links via respective antennas 316 and 324. System 300 can also include one or more neighbor sectors (e.g., neighbor sectors 230), which can include a dominant interference sector 330 that has the most potential of being affected by interference caused by terminal 310 due to, for example, being the closest neighbor sector to terminal 310.

In accordance with one aspect, terminal 310 can communicate with serving sector 320 to control transmit power levels utilized by terminal 310. In one example, power control techniques utilized by terminal 310 and serving sector 320 can be based on a level of interference caused by terminal 310 at serving sector 320 and/or other sectors such as dominant interference sector 330. By utilizing interference as a factor in power control techniques employed by terminal 310 and serving sector 320, such techniques can facilitate more optimal overall performance in system 300 than similar techniques that do not take interference into account.

With reference to FIG. 3A, a reverse link transmission 318 from terminal 310 to serving sector 320 is illustrated. In accordance with one aspect, entities in system 300 can utilize one or more reverse link traffic channel power control techniques to control the amount of resources used by terminal 310 for reverse link transmissions, thereby controlling the amount of interference caused terminal 310 at non-serving sectors such as dominant interference sector 330. By using such techniques, terminal 310 can be allowed to transmit at a power level that is appropriate while keeping intersector interference within acceptable levels. In one such technique, dominant interference sector 330 can broadcast information about interference levels it is observing to terminal 310. Terminal 310 can adjust its transmit power based on this information as well as its current transmit power and a measure of channel strengths between the terminal 310 and non-serving sectors such as dominant interference sector 330.

In accordance with another aspect, dominant interference sector 330 can transmit interference indicators, OSI indications 338, and/or other signaling to access terminal 310 on the forward link via an Other Sector Interference (OSI) indicator component 332 and one or more antennas 334. Interference indicators generated by OSI indicator component 332 can include, for example, an indication of reverse link interference present at dominant interference sector 330. In one example, OSI indications 338 generated by OSI indicator component 332 can be regular OSI indications 336 carried over forward link physical channels (e.g., F-OSICH). In another example, such channels can be given a large coverage area to facilitate decoding of the indications at terminals that are not being served by dominant interference sector 330. More particularly, a channel utilized by dominant interference sector 330 can have similar coverage to a channel utilized for transmission of acquisition pilots, which can penetrate far into neighboring sectors in system 300. In another example, regular OSI indications 336 transmitted by dominant interference sector 330 can be made decodable without the need for additional information regarding dominant interference sector 330 aside from a pilot for the sector. Due to these requirements, regular OSI indications 336 can be rate-limited to, for example, one transmission per superframe to account for the required power and time-frequency resources of such indications.

For many applications when the system 300 is fully loaded, sending OSI indications is sufficient to control interference in system 300 and/or to provide acceptable control over interference present in system 300. However, in some scenarios, a faster power control mechanism may be needed. An example of such a scenario is the case of a partially loaded system, where a single terminal 310, located near the boundary of two sectors, suddenly starts a new transmission after a long period of silence and causes a significant amount of interference to reverse link transmissions currently taking place in the neighboring sector. Using slow OSI indications over F-OSICH, it may take several superframes for the neighboring sector to force this terminal to lower its transmit power to an acceptable level. During this time, reverse link transmissions in the neighboring sector may potentially suffer from severe interference and experience a large number of packet errors.

In accordance with one aspect, it should be appreciated that long term channel qualities on the forward and reverse links are often highly correlated. Accordingly, a terminal causing strong interference at a non-serving sector on the reverse link will most likely observe a strong signal (e.g., a pilot) from that sector on the forward link, and will have that sector in its active set. Therefore, in accordance with one aspect, sectors such as dominant interference sector 330 can additionally transmit fast OSI indications 337 to terminals 310 that have dominant interference sector 330 in their active set on a lower overhead forward link control channel (e.g. a fast forward link OSI channel, F-FOSICH), in addition to the regular transmissions on F-OSICH. Since fast OSI indications 337 are intended for a more restricted group of terminals (e.g., terminals that have dominant interference sector 330 in their active set), the coverage requirement for this segment may not be as large as the F-OSICH. In this case, F-FOSICH can be present in every FL PHY frame, allowing for sectors to more rapidly suppress interference from terminals in neighboring sectors, before they cause packet errors in the present sector.

In accordance with another aspect, OSI indicator component 332 can utilize a metric based on the amount of interference it observes on different time-frequency resources to generate OSI indications 336 and/or 337. In one example, OSI indicator component 332 can utilize an average interference over all frequency resources and over a number of recent reverse link frames as a metric for generating OSI indications 336 and/or 337. For example, OSI indicator component 332 can use the regular OSI channel, F-OSICH, to control the mean interference by generating regular OSI indications 336 based on a long-term average (e.g. a filtered version) of the measured average interference over all frequency resources, and the fast OSI channel (F-FOSICH), to control the tail of the interference distribution by generating fast OSI indications 337 based on a short-term average of the interference measurements. Additionally and/or alternatively, OSI indicator component 332 can use a function of measured interference over different time-frequency resources to generate OSI indications 336 and/or 337. Further, a combination of the average and maximum interference measured over different time frequency blocks of the most recent reverse link frame can be used to generate fast OSI indications 337.

OSI indicator component 332 can convey OSI indications 336 and/or 337 to terminal 310 in various manners. By way of non-limiting example, a single OSI bit can be used by OSI indicator component 332 to provide interference information. More particularly, an OSI bit (OSIB) can be set as follows:

$${OSIB}_{m} ( n ) = \{ \begin{matrix}{}_{}^{‵}{1}{}_{}^{′} , if {IOT}_{meas , m} ( n ) \geq {IOT}_{target} , and \\ {}_{}^{‵}{0}{}_{}^{′} , i f {IOT}_{meas , m} ( n ) < {IOT}_{target} ,\end{matrix} \qquad ( 1 )$$

where IOT_{meas,m}(n) is the measured interference-over-thermal (IOT) value for an m-th sector at a time interval n and IOT_{target} is a desired operating point for the m-th sector. As used in Equation (1), IOT refers to a ratio of the total interference power observed by an access point to thermal noise power. Based on this, a specific operating point can be selected for the system and denoted as IOT_{target}. In one example, OSI can be quantized into multiple levels and accordingly comprise multiple bits. For example, an OSI indication can have two levels, such as IOT_{MIN} and IOT_{MAX}, such that if an observed IOT is between IOT_{MIN} and IOT_{MAX} no adjustment to transmit power at a terminal 310 is to be made. However, if the observed IOT is above or below the given levels, then the transmit power should be accordingly adjusted upward or downward.

In system 300, once terminal 310 receives OSI indications 336 and/or 337 from dominant interference sector 330 as illustrated by FIG. 3A, terminal 310 can adjust resources used for subsequent reverse link transmissions via a power adjustment component 312 and/or provide feedback to serving sector 320 based on the received OSI indications via a feedback component 318 as illustrated in FIG. 3B. In one example, terminal 310 can include a delta computation component 314 for computing one or more delta offset values based on OSI indications received by terminal 310 as illustrated by FIG. 3A.

In accordance with one aspect, power adjustment component 312 at terminal 310 can maintain a reference power level or power spectral density (PSD) level and can compute a transmit power or PSD for use by terminal 310 on traffic channels by adding an appropriate offset value (in dB) to the reference level. In one example, this offset can be a delta value maintained by delta computation component 314. By way of specific example, delta computation component 314 can maintain a single delta value, which can be adjusted based on both regular and/or fast OSI indications. Alternatively, delta computation component 314 can maintain two delta values, where the first delta can be based on slow OSI indications and used as a maximum for the second delta, and the second delta can be adjusted based on fast OSI indications and used for access terminal transmissions. In another example, the access terminal 310 can maintain multiple delta values Δₜₓ for a fast approach and utilize a slow OSI indicator as a maximum for adjustments to the Δₜₓ. values. Each fast delta value can then be adjusted based on OSI indication.

In another example, terminal 310 can maintain a slow delta value and provide the slow delta value to serving sector 320 via feedback component 318. In such an example, terminal 310 can maintain Δₜₓ values based on fast OSI indications. More particularly, terminal 310 can set a maximum and minimum based on traffic flow parameters, such that each Δₜₓ has a maximum upward adjustment and downward adjustment regardless of the slow delta value. Terminal 310 can then maintain delta values between the maximum and minimum indications. Based on these delta values, feedback component 318 can feed back the slow delta value for future assignments and/or feed back a Δₜₓ value for future assignments. In the case where more than one fast delta value is maintained at the access terminal 310, each delta value can correspond to a different reverse link interlace.

A power adjustment component 312 can be coupled to the delta computation component 314 via a hard-wired and/or wireless connection. In one example, power adjustment component 312 prevents fast delta adjustments from interfering with regular delta-based power control operation by limiting the range of fast delta values as described above to the slow delta value. In cases where signal distortions caused by physical channel result in loss of orthogonality and hence intrasector interference, power adjustment component 312 can also take into account requirements on the dynamic range of the received signal and limit the minimum and maximum delta values accordingly. Further, power adjustment component 312 can adjust minimum and/or maximum delta values based on information regarding an interference level being broadcast from serving sector 320.

It should be appreciated that while delta computation component 314 is illustrated in FIG. 3B as a component of terminal 310, serving sector 320 and/or another suitable network entity can also perform some or all of the calculations performed by delta computation component 314, either independently of or in cooperation with terminal 310.

By way of specific, non-limiting example, delta computation component 314 and/or power adjustment component 312 can monitor OSI bits broadcast by neighbor access points in system 300 and can be configured to only respond to an OSI bit of a dominant interference sector 330, which can have the smallest channel gain ratio of the neighbor access points. In one example, if the OSI bit of dominant interference sector 330 is set to ‘1,’ due to, for example, the access point 310 observing higher than nominal inter-sector interference, then delta computation component 314 and/or power adjustment component 312 can accordingly adjust the transmit power of terminal 310 downward. Conversely, if the OSI bit of dominant interference sector 330 is set to ‘0,’ delta computation component 314 and/or power adjustment component 312 can adjust the transmit power of terminal 310 upward. Further, delta computation component 314 and/or power adjustment component 312 can then determine a magnitude of transmit power adjustment for terminal 310 based on a current transmit power level and/or transmit power delta for terminal 310, the channel gain ratio for dominant interference sector 330, and/or other factors. Alternatively, delta computation component 314 and/or power adjustment component 312 can utilize OSI bits from more than one access point 330 and can utilize various algorithms to adjust the maximum allowable transmit power of terminal 310 based on the multiple received OSI bits.

In accordance with another aspect, terminal 310 can include a feedback component 318, which can send a transmit PSD delta computed by power adjustment component 312, one or more delta values computed by delta computation component 314, and/or a maximum number of subcarriers or subbands that terminal 310 can support at the current transmit PSD delta, N_{sb,max}(n), to serving sector 320. In addition, desired quality of service (QoS) and buffer size parameters can also be transmitted to serving sector 320 by feedback component 318. To reduce the amount of required signaling, feedback component 318 can transmit ΔP(n) and N_{sb,max}(n) at a subset of update intervals via in-band signaling on a data channel and/or by other means. It should be appreciated that a low transmit PSD delta corresponding to terminal 310 does not mean that terminal 310 is not using all of the resources available to it. Instead, terminal 310 can be given more subcarriers or subbands for transmission in order to use all its available transmit power.

In accordance with a further aspect, for each identifiable sector in system 300, terminal 310 can use a metric called ChanDiff, which is an estimate of the difference between the reverse link channel quality of an identifiable sector and the reverse link channel quality of serving sector 320 in order to determine whether to respond to an OSI indication from that sector. In one example, ChanDiff values can be computed using forward link acquisition pilots. Additionally and/or alternatively, ChanDiff values can be computed based on reverse link pilot quality indications carried on a forward link pilot quality indicator channel (e.g., F-PQICH). In another example, terminal 310 can respond to fast OSI indications only from those sectors whose forward link channel strength is within an interval around the forward link channel strength of serving sector 320. This criterion can guarantee a reasonable reliability for fast OSI indications and pilot quality indications received from those sectors. Further, it can be appreciated that terminal 310 is most likely to cause significant interference only to said sectors.

Terminal 310, via delta computation component 314 and/or other suitable components can then use the ChanDiff quantity together with a measure of a current transmit power for terminal 310, such as total transmit power or PSD offset with respect to a reference PSD (e.g., a delta value), to determine a distribution from which to draw a decision variable corresponding to that sector and/or a weight value for the corresponding decision variables. Based on the decision variables, terminal 310 can decide whether to increase or decrease its delta value.

Further, terminal 310 can use similar algorithms with similar parameters for both slow and fast delta adjustments. Alternatively, terminal 310 can use different algorithms and/or different sets of parameters to adjust different delta values. Examples of parameters that can be different for slow and fast delta adjustments are the up and down step sizes and different decision thresholds. In addition, similar information can be incorporated into PSD constraints or relative channel/interference feedback utilized by terminal 310 and/or serving sector 320. For example, a delta setting in a delta-based power control algorithm utilized by system 300 can be modified to reflect a maximum per-user interference target.

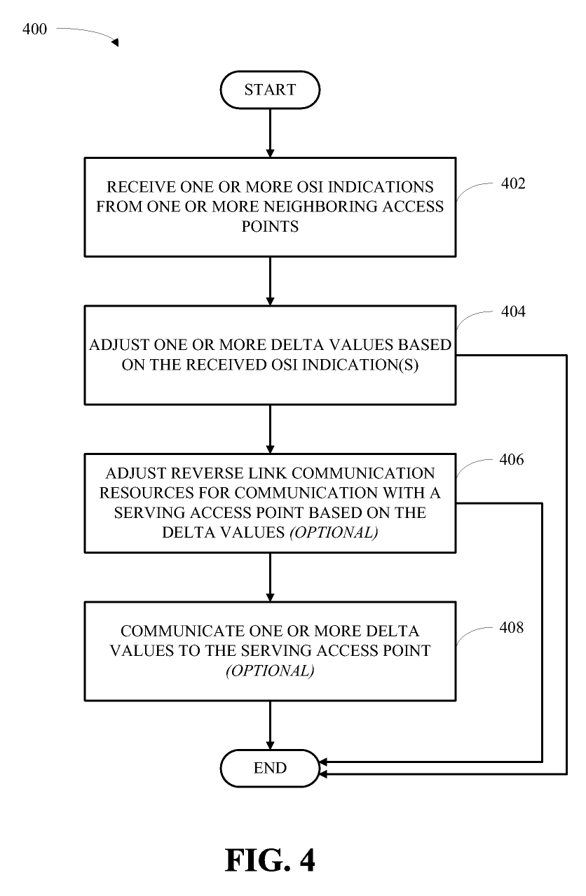

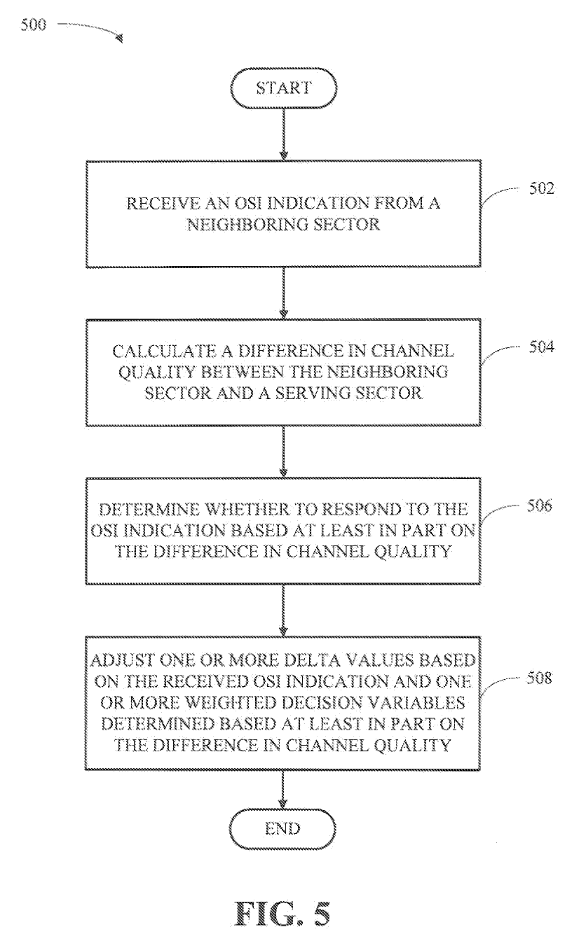

Referring to FIGS. 4-5, methodologies for power and interference control in a wireless communication system are illustrated. While, for purposes of simplicity of explanation, the methodologies are shown and described as a series of acts, it is to be understood and appreciated that the methodologies are not limited by the order of acts, as some acts can, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts can be required to implement a methodology in accordance with one or more embodiments.

With reference to FIG. 4, illustrated is a methodology 400 for providing reverse link feedback for power control and interference management in a wireless communication system (e.g., system 300). It is to be appreciated that methodology 400 can be performed by, for example, a terminal (e.g., terminal 310) and/or any other appropriate network entity. Methodology 400 begins at block 402, wherein one or more OSI indications are received from a neighboring access point (e.g., dominant interference sector 330).

In one example, OSI indications received at block 402 can be generated based on a metric that takes into account an amount of interference observed by the neighboring access point on different time-frequency resources. An example of a metric for this purpose is an average interference over all frequency resources and over a number of recent reverse link frames. For example, a neighboring access point can use a regular OSI channel, F-OSICH, to control the mean interference by generating OSI indications based on a long-term average of measured interference over all frequency resources, and a fast OSI channel (F-FOSICH), to control the tail of the interference distribution by generating fast OSI indications based on a short-term average of interference measurements. In general, to generate OSI indications, a neighboring access point can use a function of measured interference over different time-frequency resources. One example of such a function that can be used for fast OSI indication generation is a combination of average and maximum interference measured over different time-frequency blocks of a recent reverse link frame.

Next, at block 404, one or more delta values can be adjusted based on OSI indications received at block 402. In one example, a single delta value can be maintained based on both regular and/or fast OSI indications. In another example, two delta values can be maintained, where the first delta is maintained based on slow OSI indications and serves as a maximum for the second delta, which is maintained based on fast OSI indications. In a further example, to prevent fast delta adjustments from interfering with regular delta-based power control operation, the range of fast delta values as computed at block 404 can be limited to the slow delta value. In cases where signal distortions caused by physical channels result in loss of orthogonality and hence intra-sector interference, adjustments at block 404 can also take into account requirements on the dynamic range of a received signal and limit the minimum and maximum delta values accordingly. Such minimum and maximum delta values can, in turn, additionally be adjusted based on interference information received from the serving access point.

Upon completing the act described at block 404, methodology 400 can conclude or optionally proceed to block 406, wherein reverse link communication resources for communication with a serving access point can be adjusted based on the delta values computed at block 404. In a specific example, adjustments at block 406 can be based on a slow delta value and a fast delta value can be computed at block 404, wherein fast delta value is used for adjustments and the slow delta value serves as a maximum for the fast delta value.

Upon completing the optional act described at block 406, methodology 400 can conclude or can optionally proceed to block 408 prior to concluding. At block 408, one or more delta values can be communicated to the serving access point. Methodology can additionally optionally proceed to block 408 after completing the acts described at blocks 404 and/or 406, wherein one or more delta values are communicated to the serving access point. In one example, multiple delta values can be maintained and transmitted to the serving access point at block 408. In addition, a report of OSI indications received at block 402 can be communicated with the delta values at block 408. In another example, a slow delta can be maintained at block 404 solely for communication to the serving access point at block 408 for assignments. Additionally and/or alternatively, one or more fast delta values can additionally be maintained at block 404 and communicated to the serving access point at block 408. In the case where more than one fast delta values are maintained at block 404, each delta value can correspond to a different reverse link interlace.

FIG. 5 illustrates a methodology 500 for conducting reverse link power control in a wireless communication system. It is to be appreciated that methodology 500 can be performed by, for example, a terminal and/or any other suitable network entity. Methodology 500 begins at block 502, wherein an OSI indication from a neighboring sector is received. An OSI indication received at block 502 can be, for example, a fast OSI indication, a slow OSI indication, and/or another suitable indication.

Next, at block 504, a difference in channel quality between the neighboring sector and serving sector can be calculated. In one example, a metric called ChanDiff can be utilized for the neighboring sector, which is an estimate of the difference between the reverse link channel quality of the neighboring sector and the reverse link channel quality of the serving sector, to determine whether to respond to an OSI indication from the neighboring sector. In another example, ChanDiff values can be computed using the forward link acquisition pilots. Alternatively, ChanDiff values can be computed based on reverse link pilot quality indications, which can carried on a forward link pilot quality indicator channel (e.g., F-PQICH).

Upon completing the act described at block 504, methodology 500 proceeds to block 506, wherein a determination is made on whether to respond to the OSI indication based at least in part on the difference in channel quality. In one example, a determination can be made at block 506 to respond to fast OSI indications only from those sectors whose forward link channel strength is within an interval around the forward link channel strength of their reverse link serving sector. This criterion can guarantee a reasonable reliability for the fast OSI indications and pilot quality indications received from those sectors.

Methodology 500 can then conclude at block 508, wherein one or more delta values based are adjusted based on the received OSI indication and one or more weighted decision variables, which can be determined based at least in part on the difference in channel quality found at block 506. In accordance with one aspect, a delta value can be adjusted at block 508 if the delta value had been used for data transmission on a previous interlace. Further, a delta value can be adjusted at block 508 in response to a corresponding OSI value obtained at block 502. Alternatively, delta adjustments can be made at block 508 at all times, including silence periods and unassigned interlaces. Adjustment decisions can also be based on a buffer size. For example, delta values can be configured to be adjusted at block 508 on all interlaces only when a non-zero buffer size exists.

In accordance with another aspect, a ChanDiff quantity can be used together with a measure of current transmit power, such as total transmit power or PSD offset with respect to a reference PSD, to determine a distribution from which to draw a decision variable corresponding to a sector and/or a weight value for a corresponding decision variable. Based on a metric, which can be a function of the weighted decision variables, delta values can be increased or decreased at block 508. Further, similar algorithms having similar sets of parameters can be utilized at block 508 for both slow and fast delta adjustments. Alternatively, different algorithms or different sets of parameters can be used to adjust different delta values.

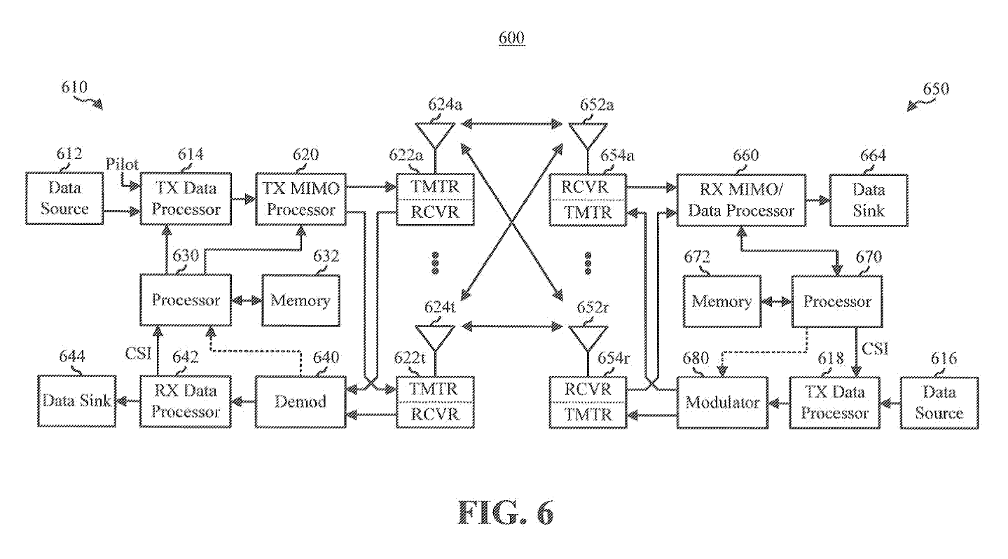

Referring now to FIG. 6, a block diagram illustrating an example wireless communication system 600 in which one or more embodiments described herein can function is provided. In one example, system 600 is a multiple-input multiple-output (MIMO) system that includes a transmitter system 610 and a receiver system 650. It should be appreciated, however, that transmitter system 610 and/or receiver system 650 could also be applied to a multi-input single-output system wherein, for example, multiple transmit antennas (e.g., on a base station), can transmit one or more symbol streams to a single antenna device (e.g., a mobile station). Additionally, it should be appreciated that aspects of transmitter system 610 and/or receiver system 650 described herein could be utilized in connection with a single output to single input antenna system.

In accordance with one aspect, traffic data for a number of data streams are provided at transmitter system 610 from a data source 612 to a transmit (TX) data processor 614. In one example, each data stream can then be transmitted via a respective transmit antenna 624. Additionally, TX data processor 614 can format, code, and interleave traffic data for each data stream based on a particular coding scheme selected for each respective data stream in order to provide coded data. In one example, the coded data for each data stream can then be multiplexed with pilot data using OFDM techniques. The pilot data can be, for example, a known data pattern that is processed in a known manner. Further, the pilot data can be used at receiver system 650 to estimate channel response. Back at transmitter system 610, the multiplexed pilot and coded data for each data stream can be modulated (i.e., symbol mapped) based on a particular modulation scheme (e.g., BPSK, QSPK, M-PSK, or M-QAM) selected for each respective data stream in order to provide modulation symbols. In one example, data rate, coding, and modulation for each data stream can be determined by instructions performed on and/or provided by processor 630.

Next, modulation symbols for all data streams can be provided to a TX processor 620, which can further process the modulation symbols (e.g., for OFDM). TX MIMO processor 620 can then provides N_{T} modulation symbol streams to N_{T} transceivers (TMTR/RCVR) 622a through 622t. In one example, each transceiver 622 can receive and process a respective symbol stream to provide one or more analog signals. Each transceiver 622 can then further condition (e.g. amplify, filter, and upconvert) the analog signals to provide a modulated signal suitable for transmission over a MIMO channel. Accordingly, N_{T} modulated signals from transceivers 622a through 622t can then be transmitted from N_{T} antennas 624a through 624t, respectively.

In accordance with another aspect, the transmitted modulated signals can be received at receiver system 650 by N_{R} antennas 652a through 652r. The received signal from each antenna 652 can then be provided to a respective transceiver (RCVR/TMTR)654. In one example, each transceiver 654 can condition (e.g., filter, amplify, and downconvert) a respective received signal, digitize the conditioned signal to provide samples, and then processes the samples to provide a corresponding “received” symbol stream. An RX MIMO/data processor 660 can then receive and process the N_{R} received symbol streams from N_{R} transceiver 654 based on a particular receiver processing technique to provide N_{T} “detected” symbol streams. In one example, each detected symbol stream can include symbols that are estimates of the modulation symbols transmitted for the corresponding data stream. RX processor 660 can then process each symbol stream at least in part by demodulating, deinterleaving, and decoding each detected symbol stream to recover traffic data for a corresponding data stream. Thus, the processing by RX data processor 660 can be complementary to that performed by TX MIMO processor 620 and TX data processor 614 at transmitter system 610. RX processor 660 can additionally provide processed symbol streams to a data sink 664.

In accordance with one aspect, the channel response estimate generated by RX processor 660 can be used to perform space/time processing at the receiver, adjust power levels, change modulation rates or schemes, and/or other appropriate actions. Additionally, RX processor 660 can further estimate channel characteristics such as, for example, signal-to-noise-and-interference ratios (SNRs) of the detected symbol streams. RX processor 660 can then provide estimated channel characteristics to a processor 670. In one example, RX processor 660 and/or processor 670 can further derive an estimate of the “operating” SNR for the system. Processor 670 can then provide channel state information (CSI), which can comprise information regarding the communication link and/or the received data stream. This information can include, for example, the operating SNR. The CSI can then be processed by a TX data processor 618, modulated by a modulator 680, conditioned by transceivers 654a through 654r, and transmitted back to transmitter system 610. In addition, a data source 616 at the receiver system 650 can provide additional data to be processed by TX data processor 618.

Back at transmitter system 610, the modulated signals from receiver system 650 can then be received by antennas 624, conditioned by transceivers 622, demodulated by a demodulator 640, and processed by a RX data processor 642 to recover the CSI reported by receiver system 650. In one example, the reported CSI can then be provided to processor 630 and used to determine data rates as well as coding and modulation schemes to be used for one or more data streams. The determined coding and modulation schemes can then be provided to transmitters 622 for quantization and/or use in later transmissions to receiver system 650. Additionally and/or alternatively, the reported CSI can be used by processor 630 to generate various controls for TX data processor 614 and TX MIMO processor 620. In another example, CSI and/or other information processed by RX data processor 642 can be provided to a data sink 644.

In one example, processor 630 at transmitter system 610 and processor 670 at receiver system 650 direct operation at their respective systems. Additionally, memory 632 at transmitter system 610 and memory 672 at receiver system 650 can provide storage for program codes and data used by processors 630 and 670, respectively. Further, at receiver system 650, various processing techniques can be used to process the N_{R} received signals to detect the N_{T} transmitted symbol streams. These receiver processing techniques can include spatial and space-time receiver processing techniques, which can also be referred to as equalization techniques, and/or “successive nulling/equalization and interference cancellation” receiver processing techniques, which can also be referred to as “successive interference cancellation” or “successive cancellation” receiver processing techniques.

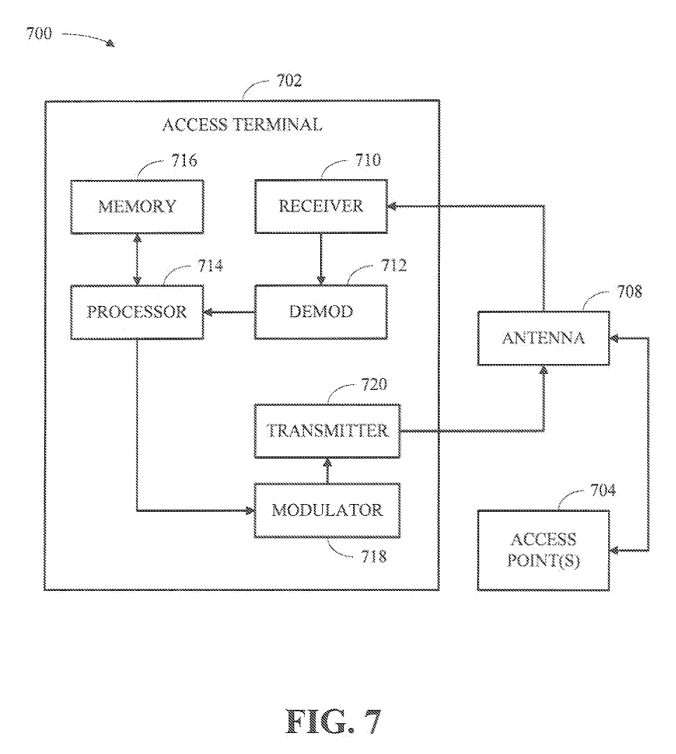

FIG. 7 is a block diagram of a system 700 that coordinates reverse link power level maintenance in a wireless communication system in accordance with various aspects described herein. In one example, system 700 includes an access terminal 702. As illustrated, access terminal 702 can receive signal(s) from one or more access points 704 and transmit to the one or more access points 704 via an antenna 708. Additionally, access terminal 702 can comprise a receiver 710 that receives information from antenna 708. In one example, receiver 710 can be operatively associated with a demodulator (Demod) 712 that demodulates received information. Demodulated symbols can then be analyzed by a processor 714. Processor 714 can be coupled to memory 716, which can store data and/or program codes related to access terminal 702. Additionally, access terminal 702 can employ processor 714 to perform methodologies 400, 500, and/or other appropriate methodologies. Access terminal 702 can also include a modulator 718 that can multiplex a signal for transmission by a transmitter 720 via antenna 708 to one or more access points 704.

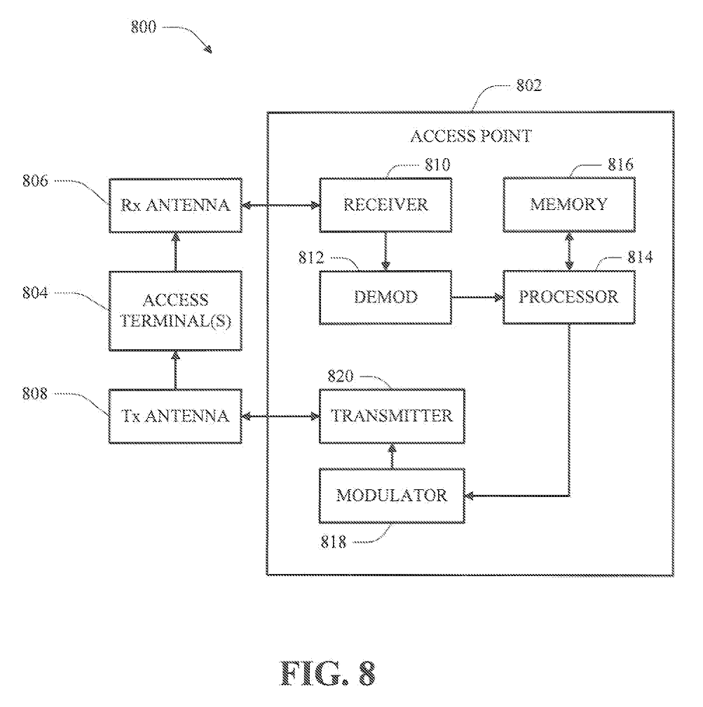

FIG. 8 is a block diagram of a system 800 that coordinates reverse link power control and interference management in a wireless communication system in accordance with various aspects described herein. In one example, system 800 includes a base station or access point 802. As illustrated, access point 802 can receive signal(s) from one or more access terminals 804 via a receive (Rx) antenna 806 and transmit to the one or more access terminals 804 via a transmit (Tx) antenna 808.

Additionally, access point 802 can comprise a receiver 810 that receives information from receive antenna 806. In one example, the receiver 810 can be operatively associated with a demodulator (Demod) 812 that demodulates received information. Demodulated symbols can then be analyzed by a processor 814. Processor 814 can be coupled to memory 816, which can store information related to code clusters, access terminal assignments, lookup tables related thereto, unique scrambling sequences, and/or other suitable types of information. Access point 802 can also include a modulator 818 that can multiplex a signal for transmission by a transmitter 820 through transmit antenna 808 to one or more access terminals 804.

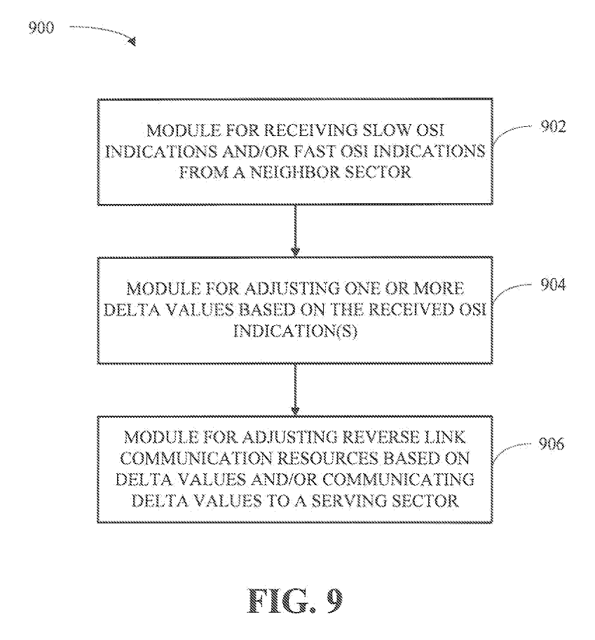

FIG. 9 illustrates an apparatus 900 that facilitates reverse link transmission resource adjustment and interference management in a wireless communication system. It is to be appreciated that apparatus 900 is represented as including functional blocks, which can be functional blocks that represent functions implemented by a processor, software, or combination thereof (e.g., firmware). Apparatus 900 can be implemented in a terminal (e.g., terminal 310) and/or another suitable network entity in a wireless communication system and can include a module for receiving slow OSI indications and/or fast OSI indications from a neighbor sector 902. Apparatus 900 can further include a module for adjusting one or more delta values based on the received OSI indication(s) 904 and a module for adjusting reverse link communication resources based on delta values and/or communicating delta values to a serving sector 906.

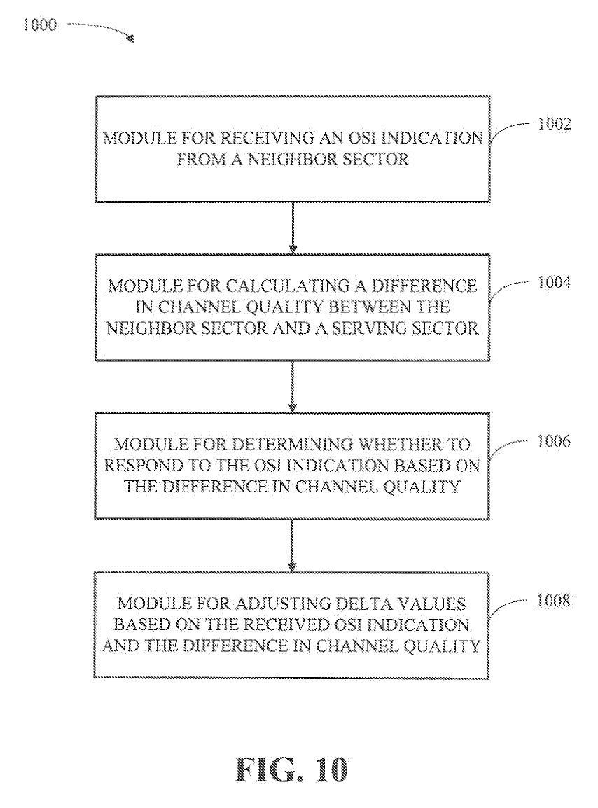

FIG. 10 illustrates an apparatus 1000 that facilitates reverse link transmission adjustment based on a received interference indication in a wireless communication system. It is to be appreciated that apparatus 1000 is represented as including functional blocks, which can be functional blocks that represent functions implemented by a processor, software, or combination thereof (e.g., firmware). Apparatus 1000 can be implemented in a terminal and/or another suitable network entity in a wireless communication system and can include a module for receiving OSI indication from a neighboring sector 1002. Further, apparatus 1000 can include a module for calculating a difference in channel quality between the neighboring sector and serving sector 1004, a module for determining whether to respond to the OSI indication based at least in part on the difference in channel quality 1006, and a module for adjusting one or more delta values based on the received OSI indication and one or more weighted decision variables determined based at least in part on the difference in channel quality 1008.

It is to be understood that the embodiments described herein can be implemented by hardware, software, firmware, middleware, microcode, or any combination thereof. When the systems and/or methods are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

What has been described above includes examples of one or more embodiments. It is, of course, not possible to describe every conceivable combination of components or methodologies for purposes of describing the aforementioned embodiments, but one of ordinary skill in the art can recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description or the claims is meant to be a “non-exclusive or.”

What is claimed is:

1. A method for providing feedback for power control in a wireless communication system, comprising:
receiving one or more other sector interference (OSI) indications from one or more neighboring access points;
maintaining one or more delta values based on the received one or more OSI indications; and
adjusting a resource used for transmissions to a serving access point based at least in part on the delta values.

2. The method of claim 1, wherein the receiving includes receiving slow OSI indications once per superframe.

3. The method of claim 1, wherein the receiving includes receiving fast OSI indications once per frame.

4. The method of claim 1, wherein the adjusting includes adjusting a bandwidth used for transmissions to the serving access point.

5. The method of claim 1, further comprising transmitting one or more delta values to the serving access point.

6. The method of claim 1, wherein the adjusting includes adjusting a power used for transmissions to the serving access point.

7. The method of claim 6, wherein the adjusting a power used for transmissions to the serving access point includes adjusting the power by adding one or more of the delta values to a reference power level.

8. The method of claim 1, wherein the delta values comprise at least one slow delta value and at least one fast delta value.

9. The method of claim 8, further comprising providing the slow delta value as feedback to the serving access point.

10. The method of claim 8, wherein the adjusting includes adjusting a resource used for transmissions to a serving access point based at least in part on the fast delta value.

11. The method of claim 8, wherein the delta values comprise a plurality of fast delta values that correspond to respective reverse link interlaces.

12. The method of claim 8, wherein the maintaining includes limiting a maximum change to a fast delta value based on the OSI indications to a slow delta value.

13. The method of claim 1, further comprising:
calculating a channel quality difference between the neighboring access point and the serving access point; and
determining whether to respond to an OSI indication based on the channel quality difference.

14. A wireless communications apparatus, comprising:
a memory that stores data relating to one or more OSI indications received from one or more non-serving sectors and one or more delta values; and
a processor configured to adjust the delta values based on the one or more OSI indications and to modify a parameter for transmissions to a serving sector based at least in part on the delta values.

15. The wireless communications apparatus of claim 14, wherein the processor is further configured to compute a new transmit power by adding a delta to a reference power level.

16. The wireless communications apparatus of claim 14, wherein the fast OSI indications are received by the wireless communications apparatus once per frame.

17. The wireless communications apparatus of claim 14, wherein the memory further stores data relating to at least one slow delta value and at least one fast delta value.

18. The wireless communications apparatus of claim 17, wherein the processor is further configured to instruct transmission of a slow delta value to the serving sector.

19. The wireless communications apparatus of claim 17, wherein the processor is further configured to adjust a fast delta value based on the fast OSI indication.

20. The wireless communications apparatus of claim 17, wherein the memory further stores data relating to a plurality of fast delta values, the fast delta values correspond to respective reverse link interlaces.

21. The wireless communications apparatus of claim 13, wherein the processor is further configured to modify a transmit power based at least in part on the delta values.

22. The wireless communications apparatus of claim 13, wherein the processor is further configured to modify a bandwidth based at least in part on the delta values.

23. An apparatus that facilitates reverse link power control and interference management in a wireless communication system, comprising:
means for receiving one or more OSI indications from one or more non-serving sectors;
means for adjusting one or more delta values based on the one or more OSI indications; and
means for modifying one or more communication resources based at least in part on the delta values.

24. The apparatus of claim 23, wherein the means for modifying one or more communication resources includes means for modifying a transmit power level at least in part by adding a delta value to a reference power level.

25. The apparatus of claim 23, wherein the delta values comprise at least one slow delta value and at least one fast delta value.

26. The apparatus of claim 25, wherein the means for adjusting one or more delta values includes means for adjusting a fast delta value based on a fast OSI indication.

27. The apparatus of claim 25, wherein the means for adjusting one or more delta values includes means for employing a slow delta value as a limit for a maximum change to a fast delta value.

28. A computer-readable storage medium, comprising:
code for causing a computer to receive one or more OSI indications from one or more non-serving base stations;
code for causing a computer to modify one or more delta values based at least in part on the one or more OSI indications; and
code for causing a computer to compute one or more of a bandwidth and a transmit power for communication with a serving base station based at least in part on the delta values.

29. The computer-readable storage medium of claim 28, wherein the code for causing a computer to receive includes code for causing a computer to receive a slow OSI indication on respective superframes.

30. The computer-readable storage medium of claim 28, wherein the code for causing a computer to compute includes code for causing a computer to compute a transmit power at least in part by adding a delta value to a reference power level.

31. The computer-readable storage medium of claim 28, further comprising code for causing a computer to transmit one or more modified delta values to the serving base station.

32. The computer-readable storage medium of claim 28, further comprising:
code for causing a computer to calculate a difference in channel quality between the non-serving base station and the serving base station; and
code for causing a computer to determine whether to respond to an OSI indication based on the difference in channel quality.

33. An integrated circuit that executes computer-executable instructions for interference control in a wireless communication system, the instructions comprising:
maintaining a reference power level;
receiving one or more OSI indications;
adjusting one or more delta values based on the received one or more OSI indications; and
computing a transmit power at least in part by adding one or more of the delta values to the reference power level.

34. The integrated circuit of claim 33, wherein the receiving includes receiving a slow OSI indication on respective superframes.

35. The integrated circuit of claim 33, wherein the receiving includes receiving a fast OSI indication on respective frames.

36. The integrated circuit of claim 33, the instructions further comprising:
calculating a channel quality difference between a serving sector and one or more sectors from which the OSI indications are received; and
determining whether to respond to an OSI indication based at least in part on the channel quality difference.

37. The integrated circuit of claim 33, wherein the adjusting includes adjusting at least one slow delta value and at least one fast delta value.

38. The integrated circuit of claim 37, wherein the adjusting includes adjusting a plurality of fast delta values corresponding to respective reverse link interlaces.
